(19) United States
(12) Patent Application Publication
(10) Pub. No.: US 2007/0153003 A1
(43) Pub. Date: Jul. 5, 2007

(54) Font-size changing and printing method, and host and printer therefor

(75) Inventor: Myung-yul Jang, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/528,248

(22) Filed: Sep. 28, 2006

(30) Foreign Application Priority Data
Jan. 2, 2006 (KR) 2006-00150

(51) Int. Cl. G06T 11/00

(52) U.S. Cl. 345/472

(57) ABSTRACT

A font-size changing and printing method and a host and a printer therefor are provided. The present invention receives a before-change font size in a unit of font size generally used in software applications and an after-change font size in a unit which a user is familiar with, converts the inputted after-change font size to correspond to the unit of the inputted before-change font size, searches for the inputted before-change font size out contained in data for printing, changes the searched font size to the converted after-change font size and prints the data for printing. The present invention receives font sizes in the unit which the user is familiar with, and changes the font size and prints data in the changed font size, thereby enhancing a user's convenience.

### CROSS-REFERENCE TO RELATED APPLICATIONS

This application claims the benefit under 35 U.S.C. §119(a) of Korean Patent Application No. 2006-150, filed on Jan. 2, 2006, in the Korean Intellectual Property Office, the entire disclosure of which is hereby incorporated by reference.

### BACKGROUND OF THE INVENTION

1. Field of the Invention

The present invention relates to a font-size changing and printing method, and a host and a printer therefor. More particularly, the present invention relates to a font-size changing and printing method, and a host and a printer therefor, which receive and change a font size in a unit that a user is familiar with, and print in a changed font size, thereby enhancing a user's convenience.

2. Description of the Related Art

Font sizes, such as those used in software applications for creating documents, are not measured in a length unit that a user uses in everyday life, such as centimeters, millimeters, inches, or the like, so that the user has difficulties in determining the font sizes. That is, in order to print in a desired font size, the user selects a font size as a sample, and evaluates the font size after printing. When failing to print in the desired font size, the user must change the font size and print in the changed font size, which causes the waste of printing paper and developer such as a toner, ink, or the like.

Accordingly, there is a need for an improved method for changing the font size and an apparatus using the same.

### SUMMARY OF THE INVENTION

Exemplary embodiments of the present invention address at least the above problems and/or disadvantages and provide at least the advantages described below. Accordingly, an exemplary aspect of the present invention is to provide a font-size changing and printing method, and a host and a printer therefor, which receive and change a font size in a unit that a user is familiar with and print in a changed font size, thereby enhancing a user's convenience.

The foregoing and other objects and advantages are substantially realized by providing an exemplary font-size changing and printing method, comprising receiving a before-changing font size and an after-changing font size that are different from each other regarding a unit of font size, converting the inputted after-change font size to correspond to a unit of the before-change font size, searching for the before-change font size out of font information contained in data for printing, and changing the searched font size to the converted after-change font size.

In an exemplary embodiment, the method further comprises printing the data for printing by applying the changed font information.

In an exemplary embodiment, the before-change font size has a unit of font size used in an application by which the data for printing are created.

In an exemplary embodiment, the after-change font size has a length unit.

In an exemplary embodiment, the receiving the before-change and after-change font sizes is performed through a user interface provided in either a printer or a host controlling the printer.

In an exemplary embodiment, the changing can be performed in either a printer or a host controlling the printer.

Meanwhile, the foregoing and other exemplary objects and advantages may be substantially realized by providing a host comprising an input unit for receiving a before-change font size and an after-change font size that are different from each other regarding a unit of font size, a printer driver for converting the inputted after-change font size to correspond to a unit of the before-change font size, searching for the before-change font size out of font information contained in data for printing and changing the searched font size to the converted after-change font size, and a communication interface unit for transmitting the changed font information to a printer together with the data for printing.

In an exemplary embodiment, the before-change font size has a unit of font size used in an application by which the data for printing are created.

In an exemplary embodiment, the after-change font size has a length unit.

Further, the foregoing and other exemplary objects and advantages are substantially realized by providing a printer comprising an input unit for receiving a before-change font size and an after-change font size that are different from each other regarding a unit of font size and a printing unit for converting the inputted after-change font size to be suitable to a unit of the before-change font size, searching for the before-change font size out of font information contained in data for printing, and changing the searched font size to and printing in the converted after-change font size.

In an exemplary embodiment, the before-change font size has a unit of font size used in an application by which the data for printing are created.

In an exemplary embodiment, the after-change font size has a length unit.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a functional block diagram for showing configurations for a host and a printer according to an exemplary embodiment of the present invention;

FIG. 2 is a flow chart for explaining a printing method according to an exemplary embodiment of the present invention; and

FIG. 3 is a view for showing a user interface according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Hereinafter, exemplary embodiments of the present invention will be described in detail with reference to the accompanying drawings.

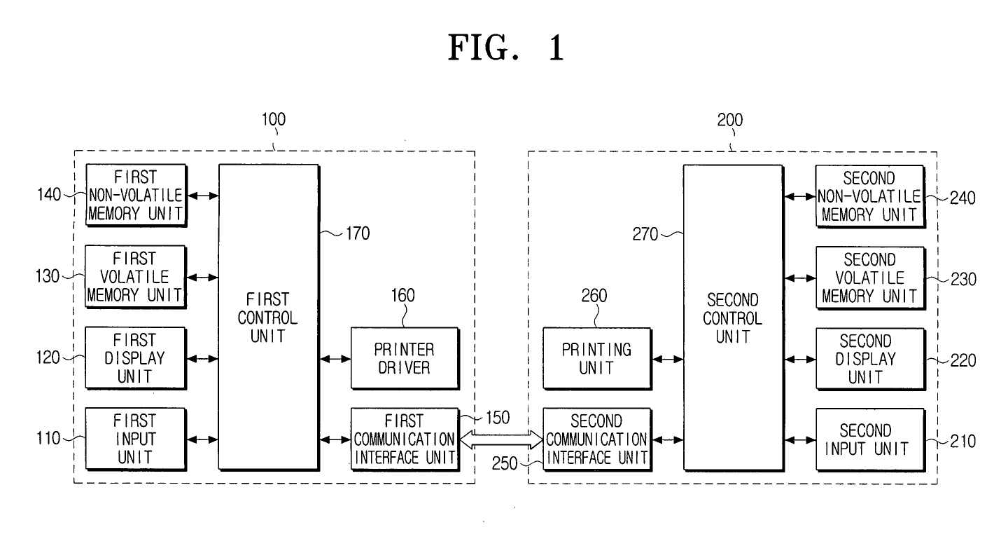

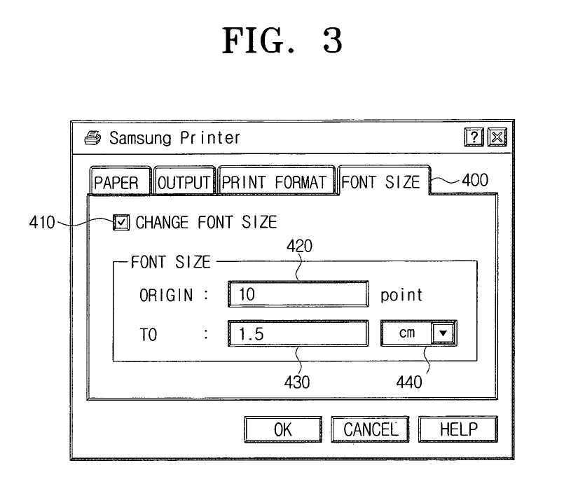

FIG. 1 is a functional block diagram for showing the configurations of a host 100 and a printer 200 according to an exemplary embodiment of the present invention, and FIG. 3 is a view for showing a user interface according to an exemplary embodiment of the present invention. Hereinafter, description will be made with reference to FIGS. 1 and 3.

The printing system of FIG. 1 includes the printer 200 for receiving data for printing from the host 100 and printing the data on printing paper, and the host 100 for controlling the printer 200.

The host 100 may include a first input unit 110, a first display unit 120, a first volatile memory unit 130, a first non-volatile memory unit 140, a first communication interface unit 150, a printer driver 160, and a first control unit 170. The host 100 can be, for example, a Personal Computer (PC), a Personal Digital Assistant (PDA), or the like.

The first input unit 110 is provided with at least one operation button for receiving various user commands. The first input unit 110 may comprise a keyboard, a mouse, or the like. After receiving an option 410 for changing font sizes, the first input unit 110 can receive a before-change font size 420 and an after-change font size 430. The units of the before-change font size may be different from the units of the after-change font size.

A signal corresponding to a user's command input through the first input unit 110 is provided to the first control unit 170. The first control unit 170 controls the host 100 in response to the signal corresponding to the inputted user's command.

The first display unit 120 responds to a user's command or displays various user alarm messages under control of the first control unit 170. The first display unit 120 can display a user interface as shown in FIG. 3.

The first volatile memory unit 130 may temporarily store data occurring during various tasks of the host 100 under control of the first control unit 170.

The first non-volatile memory unit 140 may store programs controlling the host 100 overall.

The first communication interface unit 150 is connected in a wire or a wireless manner to the second communication interface unit 250 of the printer 200, and is in charge of communications between the host 100 and the printer 200.

The printer driver 160 converts data for printing into a language, such as Page Description Language (PDL), that the printer 200 can understand, and transmits the converted data to the printer 200 through the first communication interface unit 150 under control of the first control unit 170. In this communication between the host 100 and the printer 200, font information, included in the data for printing, is transmitted to the printing unit 200.

At this time, the printer driver 160 can convert the inputted after-change font size 430 to correspond to the unit of the before-change font size 420, search for the before-change font size 420 out of the font information contained in the data for printing, and change the searched before-change font size to the converted font size.

The first control unit 170 generally controls and manages the host 100 according to the programs stored in the first non-volatile memory unit 140.

The printer 200 includes a second input unit 210, a second display unit 220, a second volatile memory unit 230, a second non-volatile memory unit 240, a second communication interface unit 250, a printing unit 260, and a second control unit 270.

The second input unit 210 is provided with at least one operation button for receiving various user's commands, and may comprise an Operating Panel Equipment (OPE) for example. The second input unit 210 can receive a before-change font size 420 and an after-change font size 430. The units of the before-change font size may be different from the units of the after-change font size.. A signal corresponding to a user's command input through the second input unit 210 is provided to the second control unit 270, and the second control unit 270 controls the printer 200 in response to the signal corresponding to the inputted user's command.

The second display unit 220 responds to a user's command, or displays various user alarm messages under control of the second control unit 270. The second display unit 220 can display a user interface such as a reference numeral 400 of FIG. 3.

The second volatile memory unit 230 may temporarily store data created during operations of the printer 200 under control of the second control unit 270.

The second non-volatile memory unit 240 may store programs generally controlling the printer 200.

The second communication interface unit 250 is connected in a wire or a wireless manner to the host 100 so as to ftmction as a path where data can be exchanged.

The printing unit 260 performs print jobs which may be received from the host 100. Also, the printing unit 260 may convert the after-change font size 430 to correspond to the unit of the before-change font size 420, search for the before-change font size 420 out of the font information contained in the data for printing, change the searched before-change font size to the converted after-change font size and perform a print job in the converted font size.

The second control unit 270 generally controls and manages the printer 200 according to the programs stored in the second non-volatile memory unit 240.

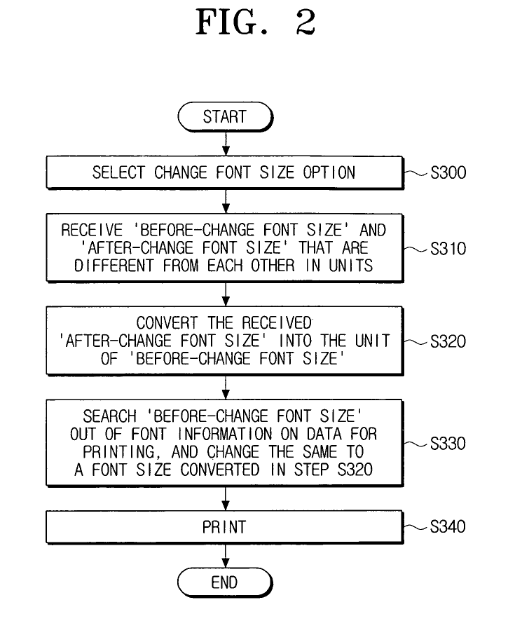

FIG. 2 is a flow chart for explaining a printing method according to an exemplary embodiment of the present invention. Hereinafter, description will be made with reference to FIGS. 2 and 3.

FIG. 3 is an example of a user interface provided by the printer driver 160, in which a tab 400 related to options for changing font sizes is provided. The first input unit 110 may receive an option of ‘change font size’ 410 from a user (S300).

In an exemplary embodiment, the first input unit 110 receives a before-change font size 420 and an after-change font size 430 (S310). The unit of the before-change font size 420 is the unit of a font size used in an application by which data for printing are created. As the unit 440 of the after-change font size 430, a length unit is used which a user generally uses in everyday life when measuring lengths of objects. The length unit can be centimeters, millimeters, inches, or the like, for example. Alternatively, as shown in FIG. 3, the unit 440 of the after-change font size 430 can be selected by a user.

Since the units of the font size used in an application are not units that a user uses in everyday life, the user can have difficulties in determining the size of the characters that will be printed. Therefore, it enables a user to use the units 440 of font size to be changed to a length unit the user uses in everyday life.

In an exemplary embodiment, a user changes a font size of 10 points of a text to a font size of 1.5 cm with respect to data for printing, by inputting data as shown in FIG. 3.

The printer driver 160 converts an after-change font size 430 input in the step S310 to correspond to the unit of a before-change font size 420 (S320). The information on points for each of 1 cm, 1 mm, and 1 inch is preset and may be stored in any of the memories 130, 140, 230 and 240. Based on the point information, an after-change font size 430 can be converted into points. For example, when 1 cm is preset at 30 points, the after-change font size 430 of 1.5 cm is converted into 45 points.

The printer driver 160 searches for the before-change font size 420 contained in the font information on data for printing, and changes the searched font size to a font size converted in the step S320 (S330). The printer driver 160 converts the data for printing into a language such as the Page Description Language (PDL) that the printer 200 can understand. Font information may be included in the data for printing, out of which a portion of a font size of 10 points being the before-change font size is changed into 45 points converted in the step S320. Font information on the data for printing may be included in the PDL as well as in the Printer Job Language (PJL).

The printer 200 receives the changed font information from the host 100 through the second communication interface unit 250 together with the data for printing, and the printing unit 260 prints the data for printing, applying the changed font information (S340).

With reference to FIG. 2, description will be made of an exemplary printing method in which the printer 200 receiving the font information together with data for printing from the host 100 changes a font size and prints in the changed font size.

If the second display unit 220 displays a user interface such as the reference numeral 400 of FIG. 3, the second input unit 210 receives an option of ‘Change Font Size’ 410 from a user (S300).

The second input unit 210 receives a before-change font size 420 and an after-change font size 430 (S310). The unit of the before-change font size 420 is a unit used by an application in which data for printing is written. As a unit 440 of the after-change font size 430, a length unit that a user generally uses in everyday life when measuring lengths of objects is used. As explained above, the length unit may be centimeters, millimeters, inches, or the like. Alternatively, as shown in FIG. 3, the unit 440 of the after-change font size 430 can be selected by the user.

The printing unit 260 converts the after-change font size 430 inputted in the step S310 to be suitable to the unit of a before-change font size 420 (S320). Based on preset information on points for 1 cm, 1 mm, and 1 inch, the after-change font size 430 can be converted into units of points.

The printing unit 260 searches for the before-change font size 420 out of the font information contained in the data for printing, and changes the searched font size into a font size converted in the step S320 (S330). The data for printing received from the host 100 contains font information, out of which a portion of a font size being the before-change font size 420 is changed into a font size converted in the step S320. The font information on the data for printing can be included in the PDL or PJL which is received from the host 100.

The printing unit 260 converts the data for printing into bitmap data, and prints the bitmap data (S340).

Alternatively, if the host 100 receives a before-change font size 420, an after-change font size 430, a unit 440, and the like, through the user interface as shown in FIG. 3 and transmits the same to the printer 200, the printing unit 260 of the printer 200 can convert the after-change font size 430 to be suitable to the unit of the before-change font size 420, search for the before-change font size 420 out of the font information contained in the data for printing, change the searched font size to the converted font size, and print in the converted font size.

As stated above, exemplary embodiments of the present invention receive a font size in the unit that a user is familiar with and changes the font size and prints data in the changed font size, thereby enhancing a user's convenience.

Certain exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains

As aforementioned, the exemplary embodiments of the present invention are shown and described, but the present invention is not limited to the specific embodiments described above, and can be implemented in various modifications by those skilled in the art to which the present invention pertains without departing from the scope of the invention as defined by the appended claims and the full scope of equivalents thereof.

What is claimed is:

1. A font-size changing and printing method, comprising:
receiving a before-changing font size expressed in a first unit and an after-changing font size expressed in a second unit, the first unit being different from the second unit;
converting the received after-change font size to the first unit of the before-change font size; and
searching for the before-change font size out of font information contained in data for printing, and changing the searched font size to the converted after-change font size.

2. The method as claimed in claim 1, further comprising printing the data for printing.

3. The method of as claimed in claim 2, wherein the printing the data for printing comprises applying the changed font size.

4. The method as claimed in claim 1, wherein the first unit of the before-change font size comprises a unit of font size used in an application by which the data for printing are created.

5. The method as claimed in claim 1, wherein the second unit of the after-change font size comprises a length unit.

6. The method as claimed in claim 1, wherein the receiving the before-change and after-change font sizes comprises receiving the before-change and after-change font sizes through a user interface provided in either a printer or a host controlling the printer.

7. The method as claimed in claim 1, wherein the changing comprises changing in either a printer or a host controlling the printer.

8. A host, comprising:
an input unit for receiving a before-change font size expressed in a first unit and an after-change font size expressed in a second unit, the first unit being different from the second unit;
a printer driver for converting the inputted after-change font size to correspond to the first unit of the before-change font size, searching for the before-change font size contained in font information on data for printing, and changing the searched font size to the converted after-change font size; and
a communication interface unit for transmitting the changed font information to a printer together with the data for printing.

9. The host as claimed in claim 8, wherein the first unit of the before-change font size comprises a unit of font size used in an application by which the data for printing are created.

10. The host as claimed in claim 8, wherein the second unit of the after-change font size comprises a length unit.

11. A printer, comprising:
an input unit for receiving a before-change font size expressed in a first unit and an after-change font size expressed in a second unit, the first unit being different from the second; and
a printing unit for converting the inputted after-change font size to correspond to the first unit of the before-change font size, searching for the before-change font size out of font information contained in data for printing, changing the searched before-change font size to the converted after-change font size, and printing in the converted after-change font size.

12. The printer as claimed in claim 11, wherein the first unit of the before-change font size comprises a unit of font size used in an application by which the data for printing are created.

13. The printer as claimed in claim 1 1, wherein the after-change font size has a length unit.

14. A method of changing a font size, the method comprising:
receiving data for printing, the received data comprising a first font having a first size expressed in terms of a first unit;
receiving a second font having a second size expressed in terms of a second unit, the second unit being different from the first unit;
converting the second font so as to express the second font in terms of the first unit;
changing the first font in the received data to the converted second font.

15. The method of claim 14, further comprising printing the received data for printing in the converted second font.

16. The method of claim 14, wherein the first unit comprises a unit of font size used in an application by which the received data for printing is created.

17. The method of claim 16, wherein the second unit comprises a unit of length.

18. The method of claim 17 wherein the first unit comprises a unit of point and the second unit comprises a unit of at least one of centimeter (cm), millimeter (mm) and inch (in).

19. The method of claim 14 wherein the receiving the second font comprises receiving input from a user through a user interface.

20. A computer-readable medium having embodied thereon instructions for executing a font-size changing and printing method, the instructions comprising:
a first set of instructions for receiving a before-changing font size expressed in a first unit and an after-changing font size expressed in a second unit, the first unit being different from the second unit;
a second set of instructions for converting the received after-change font size to the first unit of the before-change font size; and
a third set of instructions for searching for the before-change font size out of font information contained in data for printing, and changing the searched font size to the converted after-change font size.

21. The method as claimed in claim 20, further comprising a fourth set of instructions for printing the data for printing.

22. The method of as claimed in claim 21, wherein the fourth set of instructions for printing the data for printing comprises instructions for applying the changed font size.

23. The method as claimed in claim 20, wherein the first unit of the before-change font size comprises a unit of font size used in an application by which the data for printing are created.

24. The method as claimed in claim 20, wherein the second unit of the after-change font size comprises a length unit.

25. The method as claimed in claim 20, wherein the first set of instructions for receiving the before-change and after-change font sizes comprises instructions for receiving the before-change and after-change font sizes through a user interface provided in either a printer or a host controlling the printer.

26. The method as claimed in claim 20, wherein the third set of instructions for changing comprises instructions for changing in either a printer or a host controlling the printer.
